(19) United States
(12) Patent Application Publication
(10) Pub. No.: US 2014/0049467 A1
(43) Pub. Date: Feb. 20, 2014

(54) INPUT DEVICE USING INPUT MODE DATA FROM A CONTROLLED DEVICE

(71) Applicants: Pierre-Yves Laligand, Palo Alto, CA (US); Alok Chandel, San Francisco, CA (US)

(72) Inventors: Pierre-Yves Laligand, Palo Alto, CA (US); Alok Chandel, San Francisco, CA (US)

(21) Appl. No.: 13/652,243

(22) Filed: Oct. 15, 2012

Related U.S. Application Data
(60) Provisional application No. 61/683,065, filed on Aug. 14, 2012.

(51) Int. Cl. G06F 3/033

(52) U.S. Cl. 345/157

(57) ABSTRACT

Systems and methods for determining input modes for an input device may be based upon input mode data transmitted from a controlled device. The input mode data may be associated with a first visual content displayed by the controlled device and may provide an appropriate input mode with which the user can interact with the input device. Based upon a user's interaction with the input device and the associated input mode, a second visual content may be displayed by controlled device and a second input mode data can be transmitted to input device. The second input mode data may provide a second, different input mode based upon the second visual content with which the user can interact with the input device.

### PRIORITY

This application claims priority to U.S. Provisional Patent Application Ser. No. 61/683,065, entitled “Input Device Using Input Mode Data From a Controlled Device,” filed Aug. 14, 2012, the disclosure of which is hereby incorporated by reference in its entirety.

### BACKGROUND

The subject matter described herein relates generally to the field of input devices for controlling controlled devices.

Some controlled devices, such as televisions, stereos, gaming systems, set-top boxes, etc., utilize input devices, such as a remote control, controller, etc., to control the controlled device. These input devices may include buttons, toggles, switches, etc. that may be configured to control one or more features of the controlled device (e.g., changing a channel by using a channel up or down button). Some input devices permit a user to manually switch the input device from a first mode to a second mode, thereby activating or deactivating one or more of the buttons, toggles, switches, etc.

### SUMMARY

Implementations of the apparatus, systems, and methods for switching the input mode of an input device based on input mode data provided by the controlled device are described herein.

One implementation relates to a computerized method of processing user interactions with an input device. The method may include sending a first display data representing a first visual content from a controlled device to a display; receiving first input mode data of a plurality of input mode data, where each input mode data corresponds to an input mode and the plurality of input modes include a directional input mode with directional input buttons, a text entry mode with alphabetical buttons, and a pointing device interface mode, and where the first input mode data is associated with the first visual content; transmitting the first input mode data to the input device to determine a first input mode for the input device; and receiving, at the controlled device, data that is representative of a first user interaction with the first visual content via the first input mode of the input device.

Another implementation includes a system for adapting an input device for use with a controlled device, the input device having a processing circuit operable to: receive first input data from the controlled device, the first input data being associated with a first visual content generated by the controlled device; determine a first input mode of a plurality of input modes based on the first input data, where the plurality of input modes includes a directional input mode, a text entry mode, and a pointing device interface mode; transmit a first user interaction to the controlled device that is associated with the first visual content displayed on a display associated with the controlled device; receive a second input mode data associated with a second visual content generated by the controlled device; and determine a second input mode based on the second input mode data, where the second input mode is one of a text entry mode, pointing device interface mode, television mode, directional pad mode, and numeric keypad mode.

A further implementation includes a system having an input device with an input feature, position feature, and a first processing circuit and a controlled device with a second processing circuit. The first processing circuit is operable: to receive first input mode data from the controlled device; determine a first input mode from a plurality of input modes based on the first input mode data, where the plurality of input modes include a directional input mode, a text entry mode, and a pointing device interface mode; and transmit a first user interaction to the controlled device, where the first user interaction is from one of the input feature and the position feature. The second processing circuit is operable to generate display data representing a first visual content for display, transmit the first input mode data to the input device, and receive the first user interaction from the input device.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an environment associated with a controlled device and an input device, according to an illustrative implementation;

FIG. 2 is a diagram of an input device having physical buttons, according to an illustrative implementation;

FIG. 3 is a diagram of an input device having a touch screen and shown in a first input mode, according to an illustrative implementation;

FIG. 4 is a diagram of the input device of FIG. 3 shown in a second input mode, according to an illustrative implementation;

FIG. 5 is a diagram of the input device of FIG. 3 shown in a third input mode, according to an illustrative implementation;

FIG. 6 is a diagram of the input device of FIG. 3 shown in a fourth input mode, according to an illustrative implementation;

FIG. 7 is a diagram of the input device of FIG. 3 shown in a fifth input mode, according to an illustrative implementation; and

FIG. 8 is a flow diagram of a process for adapting an input mode of an input device, according to an illustrative implementation.

Like reference numbers and designations in the various drawings indicate like elements.

### DETAILED DESCRIPTION

### I. Overview

An input device may allow a user to control or otherwise interact with a controlled device. For example, a television may have a television remote control associated with the television that can control one or more features of the television. Such an input device may include preprogrammed physical buttons or soft buttons (e.g., buttons displayed on a touch screen of a device that a user may touch to cause the input device to interact with the controlled device) for a television mode that a user may utilize to facilitate the control or other interaction with the controlled device. For example, some input devices for televisions may include channel changing input buttons, volume changing input buttons, a guide input button, a menu input button, etc.

In some situations, a pointing device interface or other spatial navigation mode (e.g., similar to a computer mouse) may be useful for navigating on a webpage. Such a pointing device interface mode may control a cursor on the controlled device by transmitting position data of the input device via a gyroscope or by a user's interaction with a touch-sensitive area on the input device (e.g., a touchpad).

In a further situation, a text entry mode may be useful to allow a user to input text to interact with the controlled device. For example, for a television with internet functionality that permits a user to search or otherwise access the internet, a text entry mode for the input device that provides a QWERTY or other keyboard may be useful for text entry. Such a keyboard may be provided as a preprogrammed physical keyboard or as a soft keyboard (e.g., a keyboard displayed on a touch screen of a device with which a user may touch a corresponding image of a key).

In yet further situations, a directional pad input (“D-pad”) mode may be useful for browsing a television optimized application. For instance, the D-pad interface may be useful when browsing an application for the selection of previously recorded television shows or movies.

Further still, a numeric keypad mode may be useful for entering a PIN or other numerical entry for a controlled device. Of course the input device may include other modes to control a controlled device.

According to some aspects of the present disclosure, the controlled device and the input device may communicate with each other. For example, the controlled device may transmit data that is representative of the state of the controlled device, the state of an application displayed by the controlled device, the state of a selected portion displayed by the controlled device, and/or the like. Similarly, the input device may transmit data to interact with or otherwise control the controlled device. With two-way communication between the input device and the controlled device, the controlled device can transmit input mode data or otherwise notify the input device of an input mode to use with the controlled device for a given state, application, etc. For example, an input device with modal keys (e.g., keys whose face can changes due to a lighting effect) could switch between a television mode having keys for a television interface that are associated with common controls for a television and a text entry mode having a QWERTY or other keyboard for a text input interface, as appropriate. Thus, the input device may receive input mode data from the controlled device to determine the appropriate input mode and/or interface for a user.

According to some aspects of the present disclosure, the input device may consist of an application running on a mobile device (e.g., phone, tablet, laptop computer). Accordingly, the input mode may correspond to a state of the application. For example, on a phone with a touch screen, a soft keyboard may be displayed for the text entry mode, a touchpad field may be displayed for a pointing device interface mode, etc.

### II. Overview of Input Device and Controlled Device

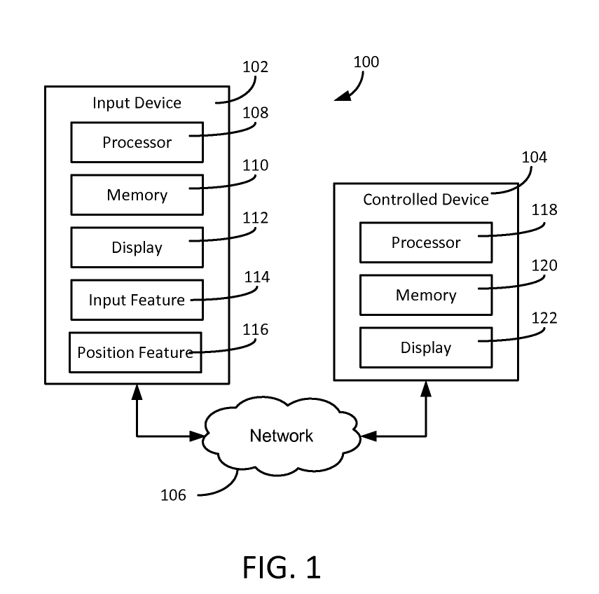

Referring to FIG. 1, a block diagram of an environment 100 associated with an input device 102 and a controlled device 104 is shown, according to an illustrative implementation. Controlled device 104 is an electronic device that may be controlled by input device 102, either directly or via a network 106. For example, controlled device 104 may be one or more of a television, a smart television, a game console, a digital video recorder, a home entertainment server, a DVD player, an FTP server, a file sharing server, a web server, or the like. Controlled device 104 may include a processor 118, a memory 120, and a display 122. Processor 118 and memory 120 may form a processing circuit. Memory 120 may store machine instructions that, when executed by processor 118 cause processor 118 to perform one or more of the operations. For example, memory 120 may store machine instructions for processor 118 to display an internet browser on display 122. Processor 118 may include a microprocessor, ASIC, FPGA, etc., or combinations thereof. Memory 120 may include, but is not limited to, electronic, optical, magnetic, or any other storage or transmission device capable of providing processor 118 with program instructions. Memory 120 may include a floppy disk, CD-ROM, DVD, magnetic disk, memory chip, ROM, RAM, EEPROM, EPROM, flash memory, optical media, or any other suitable memory from which processor 118 can read instructions. The instructions may include code from any suitable computer programming language such as, but not limited to, C, C++, C#, Java, JavaScript, Perl, HTML, XML, Python and Visual Basic.

Display 122 of controlled device 104 may include any electronic device that conveys visual information to a user (e.g., a television screen, a monitor, etc.). Display 122 may be internal to the housing of controlled device 104 (e.g., a television screen on a smart television or the like) or external to the housing of controlled device 104 (e.g., a monitor connected to controlled device 104 or the like), according to various implementations. Display 122 may include a touch screen, an LCD display, a plasma display, a projector, or the like.

Input device 102 communicates with other devices, such as controlled device 104, via network 106. Network 106 may be any form of network that relays information between input device 102, controlled device 104, and/or other devices. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, input device 102 may communicate wirelessly (e.g., via WiFi, cellular, radio, infrared, etc.) with a transceiver that is hardwired (e.g., via a fiber optic cable, a CAT5 cable, etc.) to other devices in network 106. In the implementation shown, input device 102 communicates with controlled device 104 via network 106. In some implementations, input device 102 may directly communicate with controlled device 104 without network 106. For example, input device 102 and controlled device 104 may each include a transceiver to receive and transmit data between input device 102 and controlled device 104. Though FIG. 1 depicts one controlled device 104, more than one controlled device 104 may be utilized and communicate with input device 102 in some implementations. In addition, more than one input device 102 may also be utilized with one or more controlled devices 104.

Input device 102 may be of any number of different types of user electronic devices configured to communicate with controlled device 104 (e.g., a special purpose controller; a mobile device, such as a smartphone, a tablet computer, a laptop computer; a desktop computer; combinations thereof; etc.). Input device 102 of the present example includes a processor 108, a memory 110, a display 112, an input feature 114, and a position feature 116. Processor 108 and memory 110 may form a processing circuit. Memory 110 may store machine instructions that, when executed by processor 108 cause processor 108 to perform one or more of the operations described herein. Processor 108 may include a microprocessor, ASIC, FPGA, etc., or combinations thereof. Memory 110 may include, but is not limited to, electronic, optical, magnetic, or any other storage or transmission device capable of providing processor 108 with program instructions. Memory 110 may include a floppy disk, CD-ROM, DVD, magnetic disk, memory chip, ROM, RAM, EEPROM, EPROM, flash memory, optical media, or any other suitable memory from which processor 108 can read instructions. The instructions may include code from any suitable computer programming language such as, but not limited to, C, C++, C#, Java, JavaScript, Perl, HTML, XML, Python and Visual Basic.

Input device 102 may include one or more user interface features, such as display 112, input feature 114, and position feature 116 shown in FIG. 1. A user interface feature may be any electronic feature (or a separate device) that conveys data to a user by generating sensory information (e.g., a visualization on display 112, one or more sounds, etc.) and/or converts received sensory information from a user into electronic signals (e.g., a keyboard, a mouse, a pointing device, a touch screen display, a microphone, etc.). The one or more user interface features may be internal to the housing of input device 102 (e.g., a built-in display 112, a gyroscope for position feature 116, a microphone, etc.) or external to the housing of input device 102 (e.g., a monitor connected to input device 102, a speaker connected to input device 102, etc.), according to various implementations. Display 112 of input device 102 may include an electronic display (e.g., a touch screen, an LCD, a plasma display, etc.) or may be any other visual interface with a user (e.g., LED indicators, etc.). In some implementations, display 112 may be omitted from input device 102.

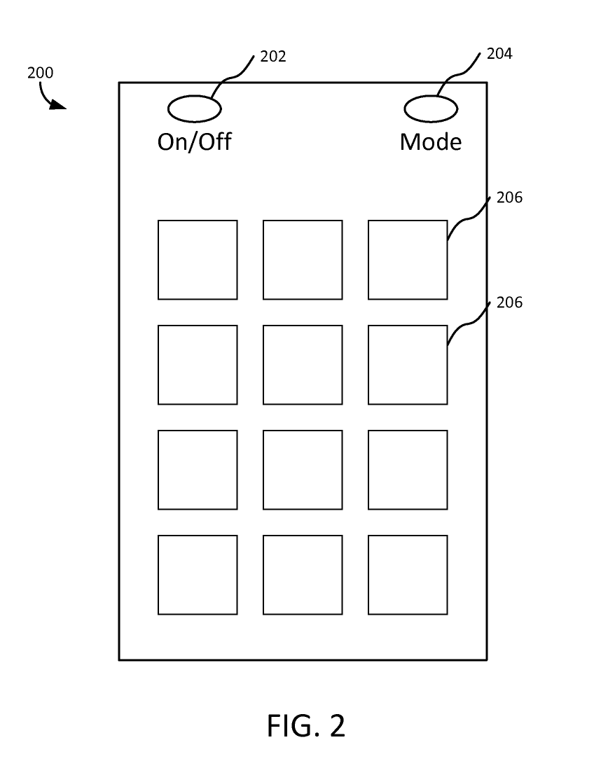

Input device 102 also includes input feature 114. In some implementations, input feature 114 may include physical buttons, toggles, switches, or the like, that a user may interact with input device 102. Referring briefly to FIG. 2, an example input device 200 may include a power input button 202, a mode input button 204, and one or more other input buttons 206. In some implementations, input buttons 206 may include push buttons corresponding to numerals 0-9 and/or buttons to increment or decrement a volume or a channel of the controlled device 104. Such buttons 202, 204, 206 may be preprogrammed for a fixed function, for example, an input button 206 corresponding to the numeral “1” being pressed or input button 202 corresponding to a power on/off instruction. In other implementations, input buttons 202, 204, 206 may incorporate aspects of both display 112 and input feature 114. For instance, input buttons 202, 204, 206 may be modal keys (e.g., keys whose faces can change due to a lighting effect) or otherwise variable buttons. Input buttons 206 may include a display, such as an embedded LCD screen, one or more LEDs, and/or other displays, such that a visual indicator or representation of input button 206 may be changed. The visual indicator for input button 206 may change when the underlying function of input button 206 is altered. For example, in a first input mode, an input button 206 may display the numeral “1” and may have a corresponding function such that pressing input button 206 results in data being transmitted to controlled device 104 corresponding to user input of the number “1” (e.g., for direct channel selection on a television). In a second input mode, input button 206 may display a symbol indicating a play function and may have a corresponding function such that pressing input button 206 results in data being transmitted to controlled device 104 corresponding to user input for the playback function. Of course further displays and corresponding functions for input buttons 206 can be implemented for input device 200.

In some implementations, data representing the one or more of the visual indicators to be displayed by input buttons 206 may be stored in memory 110 of input device 102. In other implementations, the data representing the one or more of the visual indicators to be displayed by input buttons 206 may be stored on memory 120 of controlled device 104 and the data may be transmitted to input device 102 prior to, concurrent with, and/or after input device 102 is set to a corresponding input mode. For example, data representing the visual indicators for a set of input buttons 206 for numerals 0-9 may be stored in memory 120 of controlled device 104 and transmitted to input device 102 when input device 102 is switched to an input mode utilizing input buttons having those visual indicators. In some implementations, the transmission of the data representing the visual indicators to input device 102 may occur as part of the transmission from controlled device 104 to input device 102 that provides input mode data, as will be described in greater detail below. Additionally, the underlying functions of the corresponding input buttons 206 may also be stored in memory 110 of input device 102 and/or may be stored in memory 120 of controlled device 104 and transmitted to input device 102. The functions may similarly be transmitted from controlled device 104 to input device 102 as part of the transmission from controlled device 104 to input device 102 that provides input mode data, as will be described in greater detail below. In still other implementations, the data representing the visual indicators to be displayed by input buttons 206 and/or the underlying functions may be stored by a third-party source and transmitted to input device 102 via network 106, controlled device 104, and/or otherwise.

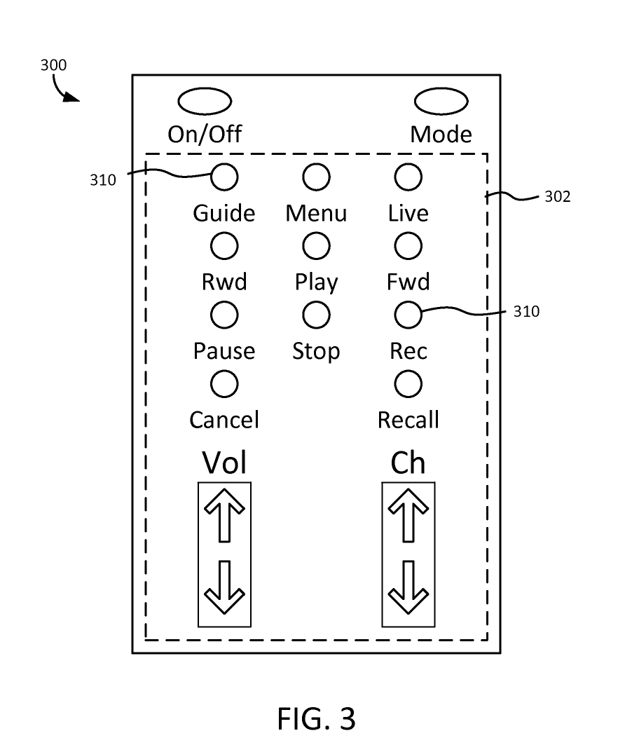

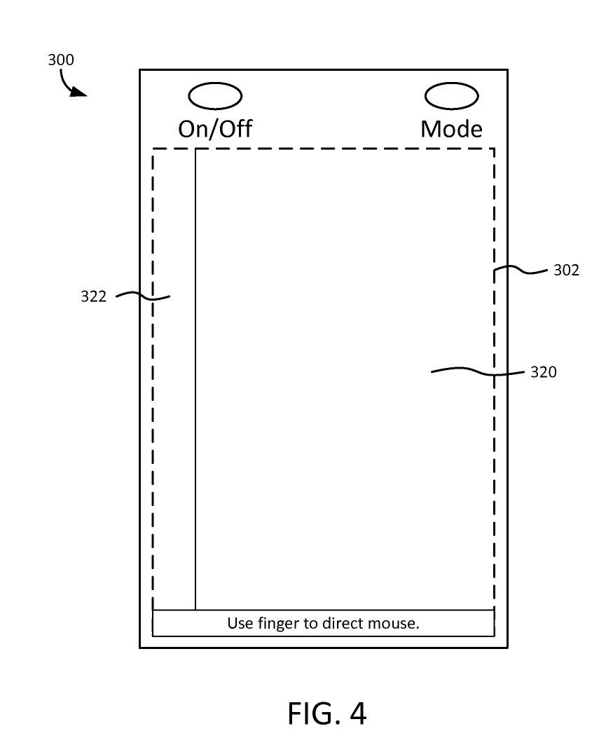

In other implementations, input feature 114 and display 112 of input device 102 may be implemented via a touch screen. The touch screen may display soft buttons (e.g., buttons displayed on the touch screen of input device 102 with which a user may touch or otherwise interact) that cause input device 102 to interact with controlled device 104. For example, briefly referring to FIG. 3, an example input device 300 may include a touch screen 302 having one or more soft buttons 310 displayed on touch screen 302. In some implementations, touch screen 302 may include a capacitive touch screen, a resistive touch screen, or the like. In the example shown in FIG. 3, a plurality of input buttons 310 corresponding to various television specific functions (e.g., guide, menu, live, volume increment and decrement, channel increment and decrement, etc.) are displayed on touch screen 302, though these are merely examples. When a user touches a portion of touch screen 302 corresponding to an input button 310, for example a portion of touch screen 302 corresponding to guide input button 310, the interaction results in data being transmitted from input device 300 to controlled device 104 that corresponds to user input for the guide function. FIGS. 4-7 likewise depict input device 300 having a touch screen 302, though different user interfaces are displayed, as will be described in greater detail below.

It should be understood that the foregoing descriptions of input devices 200, 300 are merely examples of input devices 102 that may be used with controlled device 104, and other input devices 102 may be used with controlled device 104.

Referring back to FIG. 1, input device 102 further includes a position feature 116. Position feature 116 is operable to provide data indicative of a position relative to a predetermined reference point or of a desired motion. Position feature 116 may be internal to the housing of input device 102 (e.g., a built-in gyroscope, touchpad, etc.) or external to the housing of input device 102 (e.g., a separate device that may be moved or otherwise interacted with independently of input device 102), according to various implementations. In some versions, position feature 116 may include a built-in gyroscope housed within input device 102. The gyroscope may track movement of input device 102 relative to a predetermined reference point such that input device 102 may communicate data back to controlled device 104 indicative of the movement of input device 102. Controlled device 104 may then process the data and reflect the movement of input device 102 via movement of an indicator shown on display 122. In some implementations, position feature 116 of input device 102 may be tracked by a device coupled to controlled device 104. For example, position feature 116 may comprise an indicator (e.g., physical marking, electronic signal, etc.) that may be detected by a device coupled to controlled device 104. In still a further implementation, position feature 116 may be omitted from input device 102 and movement of input device 102 and/or a user may be tracked by a device coupled to controlled device 104 (e.g., through video and/or motion capture).

Position feature 116 may include a touchpad in some implementations. For example, referring briefly to FIG. 4, input device 300 having touch screen 302 may display a touchpad 320 when input device 300 is in a mouse mode. The user may then interact with touchpad 320 via touch screen 302 and the interaction results in data being transmitted from input device 300 to controlled device 104 that corresponds to the desired movement. Controlled device 104 may then process the data and reflect the desired movement via movement of an indicator shown on display 122. Of course the foregoing position features 116 are merely examples and other position features 116 for input device 102 may be implemented.

### III. Examples of Input Modes

With controlled devices 104 that may include a variety of functions, a variety of input modes for input device 102 may be provided for a user to interact with controlled device 104. For example, in some implementations a television mode for input device 102 may be utilized with controlled device 104 when a user is viewing television on display 122. An example of such a television mode is shown in FIG. 3 for input device 300 with a touch screen 302 displaying one or more soft buttons 310. Input buttons 310 may correspond to various television specific functions, such as guide, menu, live, volume increment and decrement, channel increment and decrement, etc. When a user touches a portion of touch screen 302 corresponding to an input button 310, for example a portion of touch screen 302 corresponding to guide input button 310, the interaction results in data being transmitted from input device 300 to controlled device 104 that corresponds to user input for the selected function of the input button 310, such as a guide function in response to selection of the guide button. Of course the display, orientation, size, positioning, etc. of input buttons 310 shown in FIG. 3 is merely an example and other configurations and/or user interfaces for television mode of input device 102 may be provided.

Similarly, in some implementations a pointing device interface mode for input device 102 may be utilized with controlled device 104 when a user is navigating a webpage displayed on display 122 of controlled device. An example of such a pointing device interface mode is shown in FIG. 4 for input device 300 having a touchpad 320 displayed on touch screen 302. The user may then interact with touchpad 320 via touch screen 302 and the interaction results in data being transmitted from input device 300 to controlled device 104 that corresponds to the desired movement. Controlled device 104 may then process the data and reflect the desired movement via movement of an indicator shown on display 122. In some implementations, touchpad 320 may include a scroll region 322 that may be interacted with by a user to cause a scrolling motion similar to the use of a wheel on a physical mouse, though this is merely optional. In some other implementations, two scroll regions, one vertical and one horizontal, may be provided.

In some implementations, pointing device interface mode may cause input device 102 to interact with a gyroscope or other device associated with input device 102 that measures the position and/or orientation of input device 102. The gyroscope may track movement of input device 102 relative to a predetermined reference point such that input device 102 may communicate data back to controlled device 104 indicative of the movement of input device 102. Controlled device 104 may then process the data and reflect the movement of input device 102 via movement of an indicator shown on display 122. In some implementations, pointing device interface mode may activate a device coupled to controlled device 104 to track the movement of an indicator associated with input device 102 (e.g., physical marking, electronic signal, etc.), input device 102 itself, and/or a user (e.g., through video and/or motion capture). Of course it should be understood that other user interfaces and/or implementations for mouse mode of input device 102 may be provided.

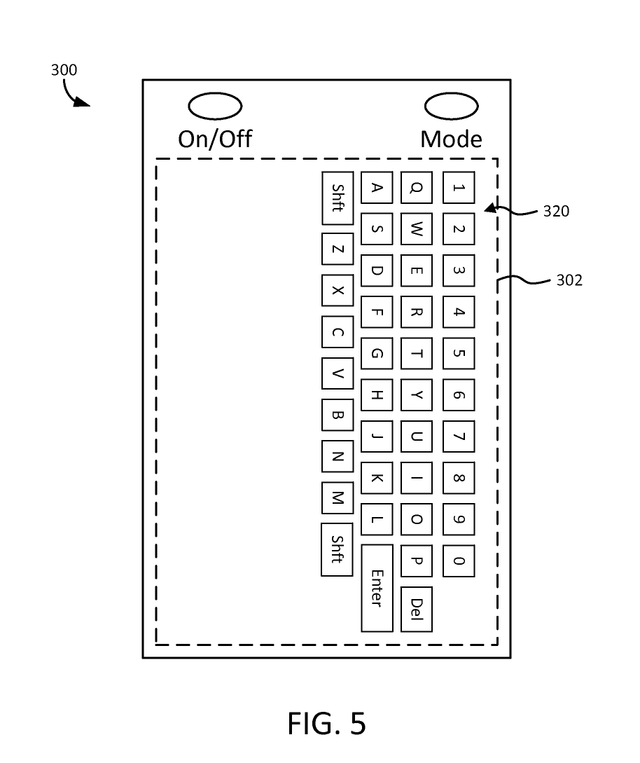

In some implementations a text entry mode for input device 102 may be utilized with controlled device 104 when a user is entering text (e.g., entering a web address, sending an e-mail or message, etc. One example of such a text entry mode is shown in FIG. 5 for input device 300 having touch screen 302. Touch screen 302 of the present example displays a QWERTY keyboard 330 with which a user may interact to enter corresponding text. For example, the user may select the displayed key for “A” by touching the portion of touch screen 302 corresponding to the displayed “A” key and input device 300 may transmit data to controlled device 104 to indicate that the user has entered text of the letter “A.” Keyboard 330 displayed on touch screen 302 may be used to enter strings of text or the like for interacting with controlled device 104. Of course other configurations for keyboard 330, text entry modes, and/or user interfaces for text entry mode for input device 102 may be provided.

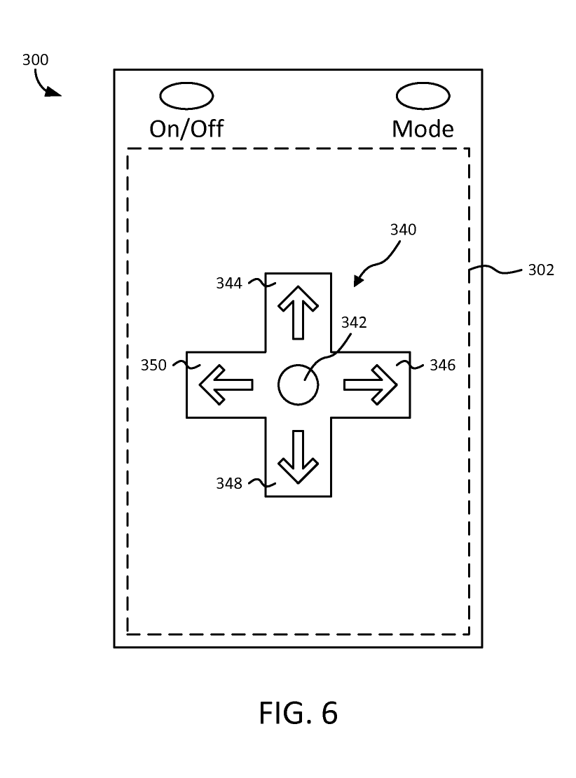

In still other implementations, a directional pad input mode for input device 102 may be utilized with controlled device 104 when a user is navigating or selecting an object displayed on display 122 of controlled device 104. For example, as shown in FIG. 6 a directional pad input mode for input device 300 may display D-pad 340 on touch screen 302. D-pad 340 includes a selection button 342, and directional buttons 344, 346, 348, 350. When a user touches a portion of touch screen 302 corresponding to directional input buttons 344, 346, 348, 350, for example a portion of touch screen 302 corresponding to the up directional input button 344, the interaction results in data being transmitted from input device 300 to controlled device 104 that corresponds to user input for the specified directional movement of an indicator on display 122 of controlled device 104. For example, in a television optimized application, such as a movie or television selection application, the user's interaction with directional input buttons 344, 346, 348, 350 may result in an indicator moving to a next object in the direction indicated. For example, indicator may include highlighting of an object, a visual representation of a cursor, or the like. When a user touches a portion of touch screen 302 corresponding to selection input button 342, the interaction results in data being transmitted from input device 300 to controlled device 104 that corresponds to user input for selecting the indicated object on display 122 of controlled device 104. Of course D-pad 340 is merely an example and other user interfaces for directional pad mode for input device 102 may be provided.

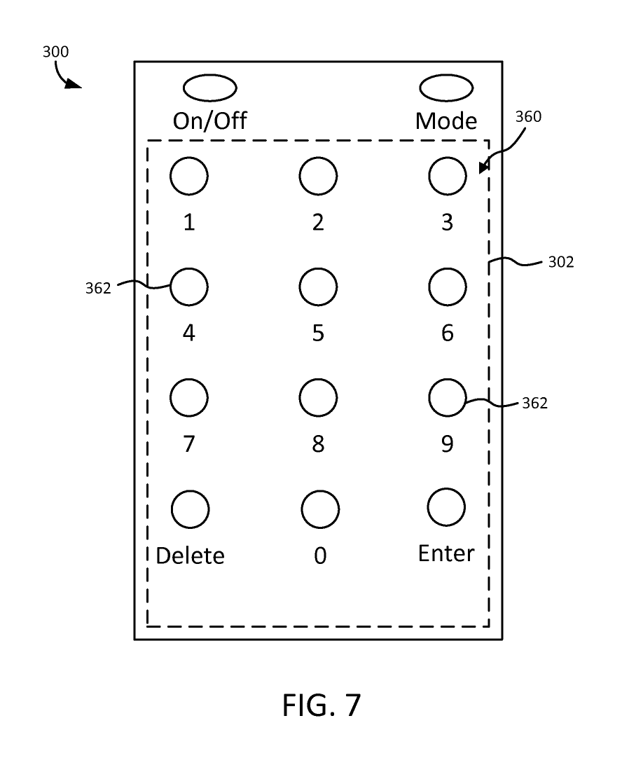

In another implementation, a numeric keypad mode may be provided for input device 102 may be utilized with controlled device 104 when a user is entering numbers into a field that requires the entry of numbers (e.g., a PIN entry field, a date of birth field, etc.). For example, as shown in FIG. 7 a numeric keypad mode for input device 300 may display a numeric keypad pad 360 on touch screen 302. Numeric keypad pad 360 includes a plurality of input buttons 362 for numerals 0-9, enter, and delete, though these are merely examples and other input buttons 362 may be displayed. When a user touches a portion of touch screen 302 corresponding to an input button 362, for example a portion of touch screen 302 corresponding to the input button 362 for numeral 9, the interaction results in data being transmitted from input device 300 to controlled device 104 that corresponds to user input for the desired numeral, entry, or deletion. Of course numeric keypad 360 is merely an example and other user interfaces for numeric keypad mode for input device 102 may be provided.

While the foregoing has described some examples of input modes for input devices 102, 300, other input modes may be provided. In addition, it should be understood that the forgoing examples of input modes are not limited to those displayed by a touch screen. Indeed, in some implementations, the foregoing input modes may be provided by modal keys, such as those described above in reference to input device 200 of FIG. 2. Further still, it should be understood that features of any of the foregoing input modes may be combined with features of the other input modes. For example, a pointing device interface mode and text entry mode may be combined to provide a touchpad 320 and keyboard 330. In other implementations, features of an input mode may be omitted from the foregoing examples. For instance, input buttons 310 for guide, live, recall, cancel, and channel increment and decrement may be omitted from the displayed user interface when a user is viewing a movie.

It should be understood that any or all of the foregoing input modes may be implemented using physical buttons. By way of example only, similar to D-pad shown in FIG. 6, an input device may include a physical D-pad having a selection button and directional buttons. Such physical directional buttons may be configured to function as up, down, left, or right directional controls in some modes. The directional buttons may function as scrolling buttons, page down/up buttons, and/or otherwise in other modes. The selection button may function as an OK or selection button in different modes. Of course it should be understood that any or all of the other input modes described in reference to FIGS. 2-7 may be implemented with physical buttons such that a touch screen may be omitted from the input device 200, 300. Input device 200, 300 may have still other configurations and/or input modes implemented with physical buttons or via touch screen 302. In a further implementation, physical or mechanical buttons may each have an indicator light showing an icon that indicates the function of each button. The icon may change color or form or shape in response to a change in mode of the input device to communicate to the user the function that the button will perform and/or the mode the input device is in.

### IV. Input Mode Data and Input Device Interaction with Controlled Device

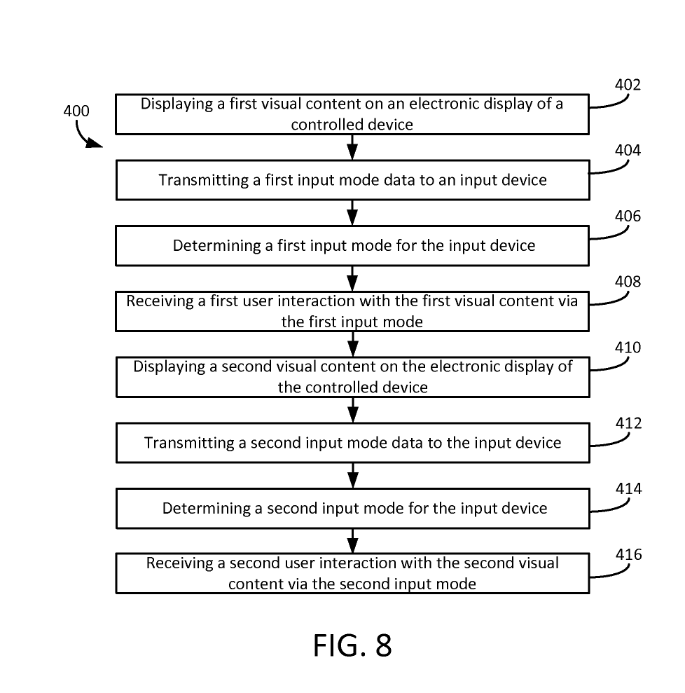

Referring now to FIG. 8, an example process 400 for changing input modes of an input device is shown. In general, process 400 enables the input device to be changed based upon the input mode indicated by an input mode data from a controlled device. Process 400 may be implemented by any number of devices for input device and/or controlled device. For example, process 400 may be implemented by input device 102 and controlled device 104 shown in FIG. 1. In another example, process 400 may be implemented by an input device 200 (shown in FIG. 2) or input device 300 (shown in FIGS. 3-7). In some implementations, process 400 may be incorporated into a device having physical buttons, as will be described below.

Process 400 may include displaying a first visual content on an electronic display of a controlled device (block 402). For example, controlled device may be controlled device 104 having display 122. Controlled device 104 may be provided display data to display the first visual content from a variety of sources, such as a satellite or cable television box, a network, a third-party server, or the like. In some implementations, controlled device 104 may generate the display data that is representative of the first visual content (e.g., controlled device 104 may be a set top box). In some implementations, the display data may be locally stored in memory 120 of controlled device 104. For example, an application may be pre-stored or downloaded to a smart television and stored in memory 120. The data may be processed by processor 118 of controlled device 104 and display data may be output to display 122 to visually display the first visual content on display 122. Some examples of such display data and content include a web browser showing a website, a television program, a movie, an e-mail application, a video game, a messaging application, a television optimized application, combinations thereof, etc. In one example, which will be used as an example to explain process 400, the first visual content may be a television optimized application for selecting and viewing television programs or movies and a second visual content may be a television program or movie, though these are merely examples.

Process 400 may include transmitting a first input mode data to an input device (block 404). The display data representing the first visual content displayed by the display of the controlled device may include an input mode data that may be transmitted to the input device. The input mode data may be transmitted from the controlled device to the input device to notify the input device of a corresponding input mode for the input device. Referring back to FIG. 1, the input mode data may be transmitted via network 106 to input device 102 or, in some implementations, the input mode data may be directly transmitted from controlled device 104 to input device 102 without network 106. One example of input mode data may be “input_mode=4,” where the value of the variable input_mode is mapped to a first input mode for the input device, as will be described below. Another example of an input mode data may include data indicating a state of controlled device 104, such as data indicating a specific application that is running on controlled device 104, whether controlled device 104 is receiving a television program, whether a movie (either from a device coupled to controlled device 104, streaming over the Internet, or otherwise) is playing, etc. Another example of an input mode data may include a prior user interaction, for instance, if the user previously selected a web browser or selected music to be played, then the input mode data may include data indicative of the user's selection. Of course other input mode data may be utilized, including data representative of or associated with all or part of the visual content displayed on display and/or of a state of controlled device 104. In some implementations, the input mode data may be included with the display data from a content source. For example, if a television optimized application is displayed on display 122 of controlled device 104, the display data for the application may include the input mode data that may be transmitted to input device 102 to indicate the first input mode to be utilized for that application. In other implementations, the display data may be provided to controlled device 104 and controlled device 104 may determine the appropriate input mode data based upon the display data received. In still another implementation, the input mode data may be separately transmitted to input device 102 from a device other than controlled device 104. For example, a third party source, such as a third-party server, may transmit the display data to a controlled device 104 and transmit the input mode data to input device 102.

Process 400 may include determining a first input mode for the input device (block 406). As noted above, in some implementations, input mode data may have a form such as “input_mode=4,” where the value of the variable input_mode is mapped to a first input mode and/or a user interface for the input device. In other implementations, if input mode data includes data indicating a state of controlled device 104, such as data indicating a specific application that is running on controlled device 104, whether controlled device 104 is receiving a television program, whether a movie (either from a device coupled to controlled device 104, streaming over the Internet, or otherwise) is playing, etc, then input device 102 may receive such input mode data and determine an input mode for input device 102 from a plurality of input modes. In still other implementations, if input mode data includes a prior user interaction, such as the user previously selecting a web browser or selecting music to be played, then input device 102 may receive such input mode data and determine an input mode for input device 102 from a plurality of input modes. One example of a first input mode that may be used with a television optimized application may be the directional pad input mode shown and described in reference to FIG. 6. Input device 300 of FIG. 6 may receive the input mode data from controlled device 104 and display D-pad 340 on touch screen 302 of input device 300. Similarly, other input mode data may be provided (e.g., other values for input_mode or the like) to display various input modes such as those described above in reference to FIGS. 3-7 or otherwise. In some implementations, the input mode data may include references to specific features and/or positions to display such features. For example, the input mode data may include instructions to map various buttons to various coordinates of a touch screen or to various modal keys. Accordingly, the input mode data may not be limited to a predetermined input mode, but may be used to customize an input mode with one or more buttons and/or button templates. In still other implementations, an override may be provided for a user to select a desired input mode. For example, as shown in FIG. 2, mode button 204 may be used to cycle through input modes and/or to display a menu of various input modes with modal key buttons 206, though this is merely optional.

Process 400 may include receiving a first user interaction with the first visual content via the first input mode (block 408). With the input device displaying the first input mode, the user may interact with the input device, such as selecting a displayed button or otherwise. For example, a user may touch up directional input button 344 of D-pad 340 shown in FIG. 6. In some implementations, a stylus or other device may be used by a user to interact with input device 300. In other implementations, such as with input device 200 of FIG. 2 having physical input buttons 202, 204, 206, the user may depress the corresponding input button 202, 204, 206 to interact with input device 200. The controlled device may receive the first user interaction for the first visual content from the input device (either directly or through a network). The controlled device may then perform the desired function. For example, the user interaction with up directional input button 344 of D-pad 340 shown in FIG. 6 may result in an entry above a currently-selected entry displayed on display 122 to be highlighted or otherwise indicated.

Process 400 may include displaying a second visual content on the electronic display of the controlled device (block 410). In some implementations, the first user interaction may result in a second visual content to be displayed by display 122 of controlled device 104. For instance, a user may touch selection input button 342 of D-pad 340 shown in FIG. 6 when an indicator on display 122 is highlighting an e-mail message such that a second visual content of and e-mail message and/or a text entry box appears on display 122. In other instances, a user may touch selection input button 342 of D-pad 340 when an indicator on display 122 of controlled device 104 is highlighting a television program or movie from a television optimized application. This may result in second visual content of a corresponding television program or movie to appear on display 122. Of course further second visual contents may be provided.

Process 400 may include transmitting a second input mode data to the input device (block 412). In the example described above with the playing of a corresponding television program or movie in response to the first user interaction, controlled device 104 may transmit a second input mode data to input device 300. For instance, the input mode data may be “input_mode=3,” where the value of the variable input_mode is mapped to a second input mode for the input device that is different from the first input mode. Of course, input mode data may have other forms, such as those described above or otherwise. In some implementations, the second input mode data may be included with the display data from the content source. For example, if television program or movie is displayed on display 122 of controlled device 104, the display data for the television program or movie may include the second input mode data to be transmitted to input device 102 to indicate the second input mode to be utilized. In other implementations the display data may be provided to controlled device 104 and controlled device 104 may determine the appropriate second input mode data based upon the display data received. In still another implementation, the second input mode data may be separately transmitted to input device 300 from a device other than controlled device 104. For example, a third-party source, such as a third-party server, may transmit the display data to a controlled device 104 and send the second input mode data to input device 300.

Process 400 may include determining a second input mode for the input device (block 414). In the current example, the display of a video on display 122 of controlled device 104 may result in a second input mode data being transmitted to input device 102 that indicates the second input mode to be utilized for that second visual content. Such a second input mode data may comprise any of the input mode data described herein and/or be other input mode data. One example of a second input mode that may be used with the video displayed by display 122 may be a television mode, such as that shown and described in reference to FIG. 3. It should be understood that one or more of the input buttons 310 may be removed, replaced, added, moved, reconfigured, and/or otherwise. For instance, only playback input buttons 310 (play, pause, stop, rewind, fastforward, record, etc.) may be displayed. Input device 300 may receive the input mode data from controlled device 104 and display input buttons 310 on touch screen 302 of input device 300. In some implementations, an override may be provided for a user to select a desired second input mode. For example, as shown in FIG. 2, mode button 204 may be used to cycle through input modes and/or to display a menu of various input modes with modal key buttons 206, though this is merely optional.

Process 400 may include receiving a second user interaction with the second visual content via the second input mode (block 416). With the input device displaying the second input mode, the user may interact with the input device, such as selecting a displayed input button or otherwise. For example, a user may touch an input button 310 corresponding to the pause input button, such as that shown in FIG. 3. In some implementations, a stylus or other device may be used by a user to interact with input device 300. In other implementations, such as with input device 200 of FIG. 2 having physical input buttons 202, 204, 206, the user may depress the corresponding input button 202, 204, 206 to interact with input device 200. The controlled device may receive the second user interaction for the second visual content from the input device (either directly or through a network). Controlled device may then perform the desired function, such as pausing the television program or movie. Of course further input modes, input mode data, visual content, user interactions, user interfaces, etc. may be provided. In some implementations, process 400 may repeat one or more of blocks 402, 404, 406, 408, 410, 412, 414, 416. For example, a controlled device may transmit a third display data representing a third visual content to a display and transmit a third input mode data to an input device. Input device may then determine a third input mode from the third input mode data. A third user interaction with the third visual content may be received via the third input mode of input device.

In some implementations, process 400 may be performed by an application running on an electronic device. For example, a mobile application may perform process 400 on a mobile device (e.g., smartphone, tablet, laptop, etc.) and may receive input mode data from a controlled device 104 through a WiFi connection, Bluetooth connection, radio connection, cellular network, infrared, or the like.

In other implementations, process 400 may be implemented on an input device having physical buttons that may change functionality based upon the received input mode data. For example, as described above, an input device may include a physical D-pad that is similar to D-pad shown in FIG. 6. The physical D-pad may include a selection button and directional buttons. Such physical directional buttons may be configured to function as up, down, left, or right directional controls when the input device is in a first input more and/or when the input device receives first input mode data. When the input device is in a second input mode and/or receives a second input mode data, such directional buttons may function as side scrolling buttons and/or page down/up buttons. Similarly, the selection button may function as an OK button when the input device is in the first mode and function as a mouse click when the input device is in a second mode. Of course it should be understood process 400 may be implemented in a similar manner with any or all of the other input modes described in reference to FIGS. 2-7 having physical buttons such that a touch screen may be omitted from the input device 200, 300. Accordingly, while the configuration of the input device may remain indistinguishable between the two input modes (e.g., the input device has the same physical layout), the functions associated with the physical buttons may change based upon the input mode data received by the input device.

In some implementations, the input mode data may correspond to an activity (e.g., text entry, browsing, etc.) in addition to, or instead of, the overall visual content displayed. For example, controlled device 104 may determine that the relevant object on the screen (e.g., a text box, etc.) is active and transmits an appropriate input mode data to input device 102. In still other implementations, the input mode data may comprise a series of activities. For instance, an input mode data for searching may initially be associated with a text entry mode and may be associated with a pointing device interface mode for browsing once the text has been submitted. Thus, a single input mode data may be transmitted to input device 102 for a series of activities. Of course still further implementations may be provided for input mode data. In a further implementation, input mode data may be provided to third parties to incorporate into third-party applications or the like such that the third-parties may define the appropriate input mode data for the third-party application or the like.

It should be understood that, while process 400 has been described in one example order, one or more of the blocks 402, 404, 406, 408, 410, 412, 414, 416 may be omitted, rearranged, or otherwise.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code embodied on a tangible medium that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit)

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touchpad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A computerized method of processing user interactions with an input device, the method comprising:
sending a first display data representing a first visual content from a controlled device to a display;
receiving a first input mode data of a plurality of input mode data, wherein each input mode data of the plurality of input mode data corresponds to an input mode of a plurality of input modes, wherein the plurality of input modes comprises:
a directional input mode having a plurality of directional input buttons,
a text entry mode having a plurality of alphabetical input buttons, and
a pointing device interface mode,
wherein the first input mode data is associated with the first visual content;
transmitting the first input mode data to the input device, wherein the first input mode data is determinative, at least in part, of a first input mode for the input device; and
receiving, at a processing circuit of the controlled device, data representing a first user interaction associated with the first visual content, wherein the first user interaction is received by way of the input device when in the first input mode.

2. The method of claim 1 wherein the first input mode data corresponds to a first input mode that is at least one of the text entry mode, the pointing device interface mode, a television mode comprising channel changing input buttons, the directional pad mode, and a numeric keypad mode comprising a plurality of numeral input buttons.

3. The method of claim 1 comprising:
sending a second display data representing a second visual content from a controlled device to a display;
receiving a second input mode of the plurality of input mode data, wherein the second input mode is associated with the second visual content;
transmitting the second input mode data to the input device, wherein the second input mode data is determinative, at least in part, of a second input mode for the input device.

4. The method of claim 2, wherein the second input mode data corresponds to a second input mode that is at least one of the text entry mode, the pointing device interface mode, a television mode comprising channel changing input buttons, the directional pad mode, and a numeric keypad mode comprising a plurality of numeral input buttons.

5. The method of claim 1, wherein the input device is a mobile device.

6. The method of claim 1, wherein the controlled device is a smart television.

7. The method of claim 1, wherein the first input mode data is received from a third-party source.

8. The method of claim 1, wherein the input device comprises a touch screen.

9. The method of claim 8 comprising:
receiving, at a processing circuit of the controlled device, the first display data representing the first visual content; and
determining, at a processing circuit of the controlled device, the first input mode data based upon the first display data representing the first visual content.

10. A system for adapting an input device for use with a controlled device, the input device comprising a processing circuit operable to:
receive a first input mode data from a controlled device, wherein the first input mode data is associated with a first visual content generated by the controlled device;
determine a first input mode from a plurality of input modes based, at least in part, on the first input mode data, wherein the plurality of input modes comprises:
a directional input mode having a plurality of directional input buttons,
a text entry mode having a plurality of alphabetical input buttons, and
a pointing device interface mode;
transmit a first user interaction to the controlled device, wherein the first user interaction is associated with at least part of the first visual content displayed on a display associated with the controlled device;
receive a second input mode data, wherein the second input mode data is based, at least in part, on a second visual content generated by the controlled device; and
determine a second input mode from the plurality of input modes based, at least in part, on the second input mode data, wherein the second input mode data corresponds to a second input mode that is at least one of the text entry mode, the pointing device interface mode, a television mode comprising channel changing input buttons, the directional pad mode, and a numeric keypad mode comprising a plurality of numeral input buttons.

11. The system of claim 10, wherein the first input mode data is associated with an activity associated with the first visual content.

12. The system of claim 10, wherein the processing circuit is further operable to transmit a second user interaction to the controlled device.

13. The system of claim 10, wherein the first input mode data and the second input mode data are defined by a third-party source.

14. The system of claim 10 wherein the processing circuit is further operable to:
receive a third input mode data, wherein the third input mode data is based, at least in part, on a third visual content generated by the controlled device; and
determine a third input mode from the plurality of input modes based, at least in part, on the third input mode data, wherein the third input mode data corresponds to a third input mode that is at least one of the text entry mode, the pointing device interface mode, the television mode, the directional pad mode, and the numeric keypad mode;
wherein the first input mode, second input mode, and third input mode are each a different input mode selected from the plurality of input modes.

15. The system of claim 10, wherein the controlled device is a smart television and wherein the input device is a mobile device.

16. The system of claim 10, wherein the input device comprises modal keys.

17. A system comprising:
an input device comprising:
an input feature,
a position feature, and
a first processing circuit; and
a controlled device comprising:
a second processing circuit;
wherein the first processing circuit of the input device is operable to:
receive a first input mode data from the controlled device,
determine a first input mode from a plurality of input modes based, at least in part, on the first input mode data,
wherein the plurality of input modes comprises:
a directional input mode having a plurality of directional input buttons,
a text entry mode having a plurality of alphabetical input buttons, and
a pointing device interface mode, and
transmit a first user interaction to the controlled device,
wherein the first user interaction is received from at least one of the input feature and the position feature,
wherein the second processing circuit is operable to:
generate display data representing a first visual content for display,
transmit the first input mode data to the input device, and receive the first user interaction from the input device.

18. The system of claim 17, wherein the input device comprises a mobile device and the position feature comprises a gyroscope.

19. The system of claim 18, wherein the controlled device comprises a smart television.

20. The system of claim 19, wherein the first input mode is at least one of the text entry mode, the pointing device interface mode, a television mode comprising channel changing input buttons, the directional pad mode, and a numeric keypad mode comprising a plurality of numeral input buttons.
